(19) United States
(12) Patent Application Publication
(10) Pub. No.: US 2007/0237246 A1
(43) Pub. Date: Oct. 11, 2007

(54) Wireless modem, modulator, and demodulator

(76) Inventors: In Gi Lim, Yuseong-gu (KR); Hyung Il Park, Daejeon (KR); Young Seok Baek, Daejeon (KR); Hyuk Kim, Daejeon (KR); Tae Joon Kim, Seoul (KR); Kyung Soo Kim, Daejeon (KR); Ik Soo Eo, Daejeon (KR); Hee Bum Jung, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/496,897

(22) Filed: Aug. 1, 2006

(30) Foreign Application Priority Data
Apr. 11, 2006 (KR) 10-2006-0032627

(51) Int. Cl. H04K 1/10

(52) U.S. Cl. 375/260

(57) ABSTRACT

A wireless modem is mounted to a terminal for wireless communication, and specifically controls an internal drive clock to reduce power consumption in an active mode. The wireless modem includes: a wireless core module for transmitting and receiving a radio signal; a modulator for converting data to be transmitted into a wireless transmission signal and transmitting the converted signal to the wireless core module; a demodulator for converting the signal received from the wireless core module into reception data; a synchronizer for synchronizing the signal received from the wireless core module; and a clock controller for generating a drive clock of each of the modulator, the demodulator, and the synchronizer. A low power clock controller is divided into six main functional blocks of a synchronizer, an analog controller, a modulator, a channel decoder, a demodulator, and a channel encoder, and has a feature that a clock is input only when a main functional block operates. As a result, it is possible to minimize power consumption caused by clock switching when an Orthogonal Frequency Division Multiplexing Access (OFDMA) mobile station modem operates in an active mode through the clock controller.

### CROSS-REFERENCE TO RELATED APPLICATION

This application claims priority to and the benefit of Korean Patent Application No. 2006-32627, filed Apr. 11, 2006, the disclosure of which is incorporated herein by reference in its entirety.

### BACKGROUND

1. Field of the Invention

The present invention relates to a wireless modem mounted to a terminal for wireless communication, and more particularly, to a wireless modem controlling an internal drive clock to reduce power consumption in an active mode. In particular, the idea of the present invention can be usefully applied to the design of an Orthogonal Frequency Division Multiple Access (OFDMA) mobile station modem chip.

2. Discussion of Related Art

Current wireless communication using an Orthogonal Frequency Division Multiplexing (OFDM) or Orthogonal Frequency Division Multiple Access (OFDMA) modulation system includes Wireless Local Area Network (WLAN), Worldwide Interoperability for Microwave Access (WiMAX), Mobile WiMAX, Wireless Broadband (WiBro), and so on. According to the trend of technologies for supporting these standards, it is essential for a mobile station modem to operate with low power in order to support higher speed data services, various multimedia, and mobility. To this end, various clock control technologies are introduced.

A mobile terminal operates in various operation modes, which are divided into an active mode in which data and a control signal are normally received and transmitted between a base station and the mobile terminal and a main clock is used, an idle mode in which only the control signal is received and transmitted between the base station and the terminal, and a sleep mode in which the data and control signal are not received and transmitted between the base station and the terminal and a low clock divided from the main clock is used.

With respect to clock control of the low-power mobile station modem, a method for controlling an idle mode and a sleep mode is disclosed in Korean Patent Application No. 2000-0051124, and a method for intercepting a clock during an idle interval in a system that includes Digital Signal Processor (DSP) and peripherals is also disclosed in Korean Patent Application No. 2000-0028370.

Reference will be made to the case where a conventional power-saving structure is applied to an OFDMA mobile station modem comprising main functional blocks of an analog controller, a modulator, a demodulator, a channel encoder, and a channel decoder. In this case, there is an idle interval where each functional block does not operate even within an active mode interval where a main clock is input to drive the mobile station modem. However, according to the conventional art, the main clock is provided to a corresponding functional block during the idle interval. The provision of the main clock to the functional block incurs unnecessary power consumption.

### SUMMARY OF THE INVENTION

The present invention is directed to a wireless modem, a modulator and a demodulator, capable of reducing power consumption within an active mode interval where a main clock is input.

The present invention is also directed to a wireless modem, a modulator and a demodulator, capable of reducing power consumption caused by clock switching.

The present invention is also directed to a wireless modem, a modulator and a demodulator, capable of reducing power during an idle interval of each functional block.

An aspect of the present invention provides a wireless modem, comprising: a wireless core module for transmitting and receiving a radio signal; a modulator for converting data to be transmitted into a wireless transmission signal and transmitting the converted signal to the wireless core module; a demodulator for converting the signal received from the wireless core module into reception data; a synchronizer for synchronizing the signal received from the wireless core module; and a clock controller for generating a drive clock of each of the modulator, the demodulator, and the synchronizer.

Another aspect of the present invention provides a modulator, comprising: an encoder for encoding data to be transmitted; an interleaver for rearranging output data of the encoder; a mapping block for allocating output data of the interleaver to subcarriers; an inverse Fourier transformer for converting a frequency-axis output signal of the mapping block into a time-axis signal; and a clock controller for grouping the components into at least two functional block groups, and generating a drive clock of each group.

The modulator may be divided into a block before interleaving, and a block after interleaving according to the structure performing interleaving for rearranging a sequence of digital data to be transmitted based on a predetermined criterion, and the clock controller may generate the drive clock of each of the blocks before and after the interleaving.

The modulator may be divided into a block before inverse Fourier transform, and a block after inverse Fourier transform according to the structure performing inverse Fourier transform for converting a frequency-axis signal into a time-axis signal, and the clock controller may generate the drive clock of each of the blocks before and after the inverse Fourier transform.

Yet another aspect of the present invention provides a demodulator, comprising: a Fourier transformer for converting a time-axis reception signal into a frequency-axis signal; a demapping block for extracting data superimposed on an output signal of the Fourier transformer; a deinterleaver for rearranging output data of the demapping block in original order; a decoder for decoding output of the deinterleaver; and a clock controller for grouping the components into at least two groups, and generating a drive clock of each group.

The demodulator may be divided into a block before deinterleaving, and a block after deinterleaving according to the structure performing deinterleaving for rearranging received digital data in original order, and the clock controller may generate the drive clock of each of the blocks before and after the deinterleaving.

The demodulator may be divided into a block before Fourier transform, and a block after Fourier transform according to the structure performing Fourier transform for converting a time-axis signal into a frequency-axis signal, and the clock controller may generate the drive clock of each of the blocks before and after the Fourier transform.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 illustrates the configuration of an Orthogonal Frequency Division Multiple Access (OFDMA) data frame used in an OFDMA system;

FIG. 2 is a block diagram illustrating an internal structure of an OFDMA mobile station modem according to an exemplary embodiment of the present invention;

FIG. 3 is a timing diagram of signals generated by a clock controller according to an exemplary embodiment of the present invention; and

FIG. 4 is a detailed circuit diagram illustrating a functional block structure in the clock controller according to an exemplary embodiment of the present invention.

### DETAILED DESCRIPTION OF PREFERRED EMBODIMENTS

Hereinafter, an exemplary embodiment of the present invention will be described in detail. However, the present invention is not limited to the embodiments disclosed below, but can be implemented in various types. Therefore, the present embodiment is provided for complete disclosure of the present invention and to fully inform the scope of the present invention to those ordinarily skilled in the art.

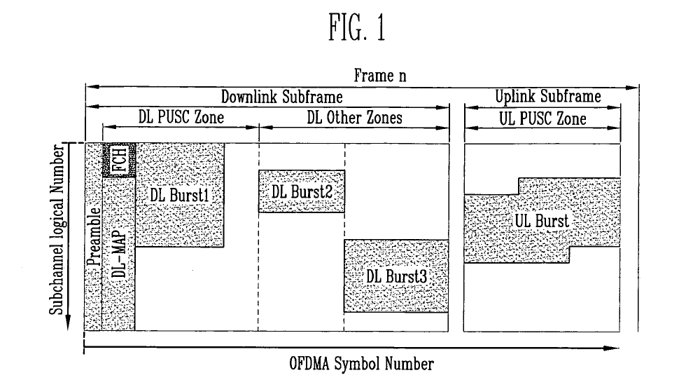

FIG. 1 illustrates a frame structure of an Orthogonal Frequency Division Multiple Access (OFDMA) system having a Time Division Duplex (TDD) mode.

In FIG. 1, a horizontal axis represents an OFDMA symbol number in a time domain, and a vertical axis represents a sub-channel logical number in a frequency domain. A frame is comprised of a downlink sub-frame, an uplink sub-frame, a Transmit/receive Transition Gap (TTG), and a Receive/transmit Transition Gap (RTG). The downlink sub-frame is divided into a preamble, and a plurality of downlink zones. In the first downlink zone (DL Partially Used Sub-Carrier (PUSC) Zone), there are a Frame Control Header (FCH), a DL-Media Access Protocol (MAP), and a downstream link burst allocated to each terminal as a communication channel for reception. Other downlink zones also comprise such downstream link bursts. The uplink sub-frame comprises an uplink zone (UL PUSC Zone), which comprises an upstream link burst allocated to each terminal as a communication channel for transmission.

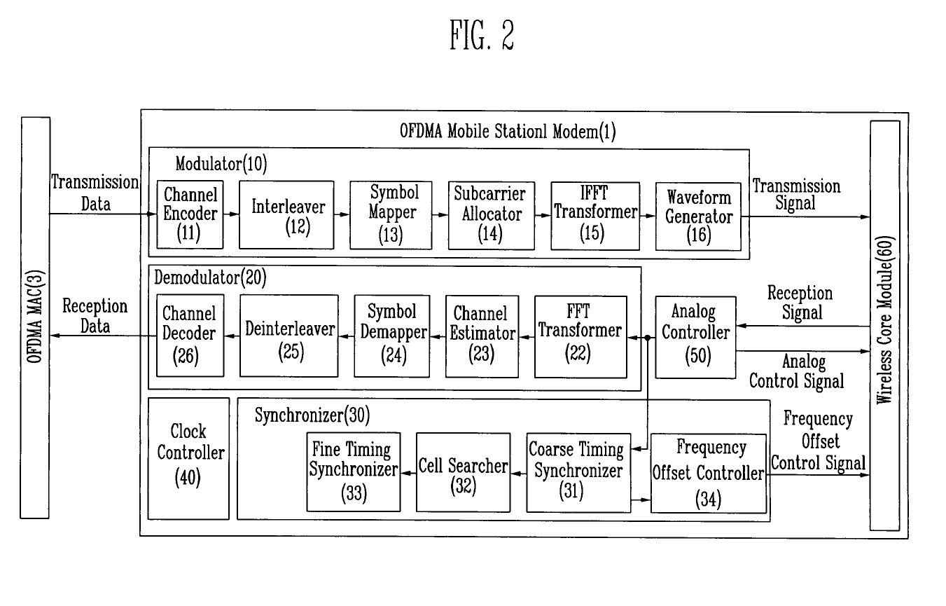

FIG. 2 is a block diagram illustrating an internal structure of an OFDMA mobile station modem according to an exemplary embodiment of the present invention.

As illustrated, the OFDMA mobile station modem 1 can be generally divided into a modulator 10, a demodulator 20, a synchronizer 30, a clock controller 40, and a wireless core module 60 for receiving a radio signal.

The modulator 10 receives digital data to be transmitted to a wireless channel from an OFDMA Medium Access Control (MAC) layer component 3, encodes the data at a channel encoder 11, and transmits an analog transmission signal, which is generated through an interleaver 12, a symbol mapper 13, a subcarrier allocator 14, an Inverse Fast Fourier Transform (IFFT) transformer 15, and a waveform generator 16, to the OFDMA wireless core module 60. The interleaver 12 is for rearranging a sequence of digital data to be transmitted to be suitable for a wireless channel for transmission. A rule by which interleaving is carried out depends on a type of a communication system (e.g., CDMA, FDMA, etc.).

The demodulator 20 receives an analog reception signal from the OFDMA wireless core module 60, and transmits digital reception data, which is demodulated through a Fast Fourier Transform (FFT) transformer 22, a channel estimator 23, a symbol demapper 24, a deinterleaver 25, and a channel decoder 26, to the OFDMA MAC layer component 3. The analog controller 50 controls environment variables (e.g., a Direct Current (DC) offset value, and an Automatic Gain Control (AGC) offset value) for optimizing reception of the radio signal of the OFDMA wireless core module 60.

The synchronizer 30 may comprise a coarse timing synchronizer 31 for receiving an output signal of the analog controller 50 as a reception signal and performing coarse timing synchronization using a preamble, a cell searcher 32 and a fine timing synchronizer 33 which are for performing a synchronization function, and a frequency offset controller 34 for generating a frequency offset control signal and feeding it back to the OFDMA wireless core module 60.

The clock controller 40, the feature according to the idea of the present invention, determines a start point and an end point of an interval where each component should be driven, and generates a drive clock of a corresponding component during the drive interval.

The clock controller 40 is for generating a drive clock only during the interval where each functional block constituting the modem should be driven, and can be variously implemented according to a method of dividing each functional block group. As the number of divided functional block groups is smaller, the clock controller 40 has a simpler structure, so that its implementation is easy, but an effect of reducing power consumption is lowered. Meanwhile, as the number of the divided functional block groups is greater, the clock controller 40 has a more complicated structure, so that its implementation is difficult, but the effect of reducing power consumption is enhanced.

According to an embodiment, an interleaving buffer for buffering digital data, which is input to perform the interleaving during a predetermined interval, may be further included in an input stage of the interleaver 12. In this case, the clock controller 40 may stop a drive clock of a block before interleaving when all data are received into the interleaving buffer, and start a drive clock of a block after interleaving when the data required for the interleaving is received into the interleaving buffer. Here, the interleaver 12 belongs to the block after interleaving.

According to an embodiment, an inverse Fourier buffer for buffering time-axis data obtained by inverse Fourier transform during a predetermined interval may be further included in an output stage of the IFFT transformer 15. In this case, the clock controller 40 may stop a drive clock of a block before inverse Fourier transform when all data are received into the inverse Fourier buffer, and start a drive clock of a block (the waveform generator 16 in FIG. 1) after inverse Fourier transform. Here, the IFFT transformer 15 belongs to the block before inverse Fourier transform.

According to an embodiment, a Fourier buffer for buffering time-axis data input to perform Fourier transform during a predetermined interval may be further included in an input stage of the FFT transformer 22. In this case, the clock controller 40 may stop a drive clock of a block before Fourier transform when all data are received into the Fourier buffer, and start a drive clock of a block after Fourier transform when data required for Fourier transform is received into the Fourier buffer. Here, the FFT transformer 22 belongs to the block after Fourier transform.

According to an embodiment, a deinterleaving buffer for buffering digital data obtained by deinterleaving during a predetermined interval may be further included in an output stage of the deinterleaver 25. In this case, the clock controller 40 may stop a drive clock of a block before deinterleaving when all data are received to the deinterleaving buffer, and start a drive clock of a block after deinterleaving when data required for operation of the channel decoder 26 is received into the deinterleaving buffer. Here, the deinterleaver 25 belongs to the block before deinterleaving.

Hereinafter, description will be made about controlling a drive clock of each functional block group obtained by grouping the functional blocks based on a predetermined criterion. First, the grouping of the functional blocks regarded as suitable by the inventor of the present invention will be described.

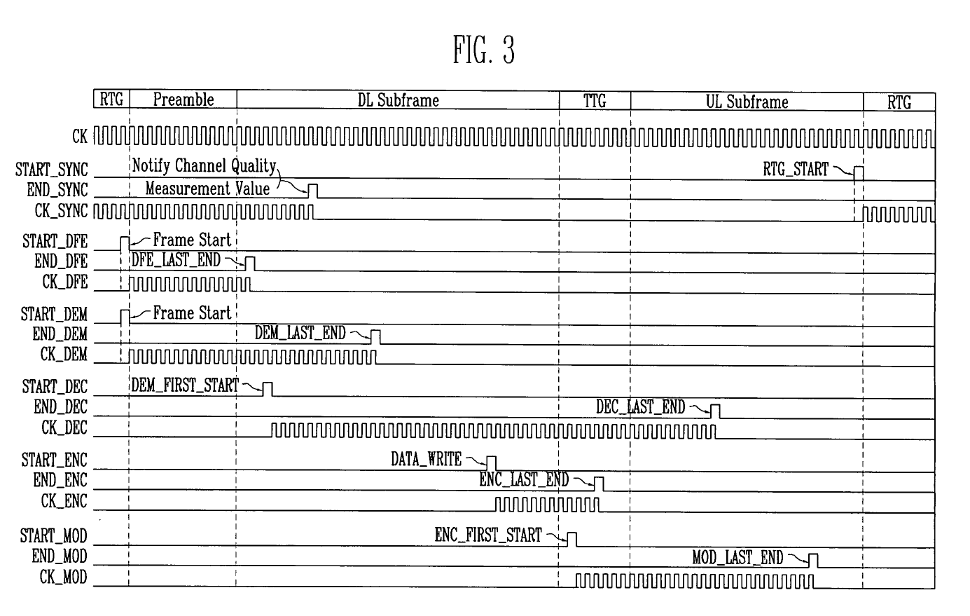

FIG. 3 is a timing diagram of a drive clock of each functional block constituting an OFDMA mobile station modem, which is implemented according to grouping of the functional blocks regarded as suitable by the inventor of the present invention. The clock controller receives a start signal START and an end signal END of a clock from each main functional block of the mobile station modem, and generates a drive clock required for each functional block. In the case of the present embodiment, the main functional blocks are grouped into the synchronizer 30, the analog controller 50, the channel decoder 26, the channel encoder 11, the modulator blocks 12 to 16 excluding the channel encoder, and the demodulator blocks 22 to 25 excluding the channel decoder. In this case, the modulator 10 is divided into two groups of blocks before and after interleaving, of which one group is one functional block before interleaving, i.e. the channel encoder 11, and the other group is several functional blocks after interleaving, i.e. the interleaver 12, the symbol mapper 13, the subcarrier allocator 14, the IFFT transformer 15, and the waveform generator 16. Also, the demodulator 20 is divided into two groups of blocks before and after deinterleaving, of which one group is one functional block before deinterleaving, i.e. the channel decoder 26, and the other group is several functional blocks after deinterleaving, i.e. the deinterleaver 25, the symbol demapper 24, the channel estimator 23, and the FFT transformer 22.

In the frame structure of FIG. 1, division of each interval (the preamble interval, the downlink sub-frame interval, the TTG interval, the uplink sub-frame interval, and the RTG interval) can be easily determined by a frame start signal by the synchronizer 30, and frame construction parameters forwarded from the base station, which are well-known in the art, and thus their detailed descriptions will be omitted.

In the active mode, the clock controller 40 generates a signal START_SYNC to start the synchronizer 30 at a start point RTG_START of the RTG interval, and activates a drive clock CK_SYNK applied to the synchronizer 30. The activated synchronizer 30 performs synchronization, and then generates a signal END_SYNC when operation of notifying a channel quality measurement value, etc., to the MAC layer component 3. The clock controller 40 receiving the signal END_SYNC inactivates the drive clock CK_SYNK applied to the synchronizer 30.

In the active mode, the clock controller 40 generates a signal START_DFE to start the analog controller 50 at the start point of the preamble interval, and activates a drive clock CK_DFE applied to the analog controller 50. The activated analog controller 50 generates a signal END_DFE at a point of time DFE_LAST_END when calculation for analog control is completed. Here, the analog controller 50 includes only a part for determining the control values (e.g., the DC offset value, and the AGC offset value) for setting a communication environment, and thus excludes a part for controlling feedback throughout the reception interval. In this case, since a part for generating a Pulse Duration Modulation (PDM) signal should operate without the idle interval at all times, and thus makes use of a main clock CK. The point of time DFE_LAST_END when the calculation is completed may be at a point of time when the control values for setting the communication environment are determined, and transmission of the determined control values to a corresponding component is completed. The clock controller 40 receiving the signal END_DFE inactivates the drive clock CK_DFE applied to the analog controller 50.

In the active mode, the synchronizer 30 generates a signal START_DEM to start the FFT transformer 22, the channel estimator 23, the symbol demapper 24, and the deinterleaver 25 at the start point of the preamble interval, and activates a drive clock CK_DEM of each of the FFT transformer 22, the channel estimator 23, the symbol demapper 24, and the deinterleaver 25. The FFT transformer 22, the channel estimator 23, the symbol demapper 24, and the deinterleaver 25 perform a function of demodulating a reception signal up to the last downstream burst, and generate a signal END_DEM at a point of time DEM_LAST_END when all data are transmitted to the channel decoder 26. The clock controller 40 receiving the signal END_DEM inactivates the drive clock CK_DEM.

In the active mode, the deinterleaver 25 generates a signal START_DEC to start the channel decoder 26 at a point of time DEM_FIRST_START when DL-MAP interleaving is completed, and then the clock controller 40 activates a drive clock CK_DEC of the channel decoder 26 based on the signal START_DEC. The activated channel decoder 26 performs channel decoding, and generates a signal END_DEC at a point of time DEC_LAST_END when the last channel decoded data is transmitted to the MAC. The clock controller 40 receiving the signal END_DEC inactivates the drive clock CK_DEC of the channel decoder.

In the active mode, the clock controller 40 generates a signal START_ENC to start the channel encoder 11 at a start point DATA WRITE where transmission data from the MAC layer component 3 is input into a register, and activates a drive clock CK_ENC of the channel encoder 1. The activated channel encoder 11 performs channel encoding, and generates a signal END_ENC at a point of time ENC_LAST_END when the last data is transmitted to the interleaver 12. The clock controller 40 receiving the signal END_ENC inactivates the drive clock CK_ENC of the channel encoder 11.

In the active mode, the channel encoded channel encoder 11 generates a signal START_MOD to start the demodulator blocks excluding the channel encoder at a point of time ENC_FIRST_START when first data is channel-encoded and transmitted to the interleaver 12. Here, the channel encoding is for correcting an error, and may be convolution encoding or turbo encoding. The clock controller 40 receiving the signal START_MOD activates a drive clock CK_MOD of the modulator blocks excluding the channel encoder 11. The activated modulator blocks perform interleaving, symbol mapping, subcarrier allocation, IFFT, waveform generation, etc., and generates a signal END_MOD at a point of time MOD_LAST_END when the last transmission signal is transmitted to the OFDMA wireless core module 60. The clock controller 40 receiving the signal END_MOD inactivates the drive clock CK_MOD.

Second, simplest division of the functional blocks will be described. When the number of functional blocks is divided in the least number, the functional blocks are divided only into the modulator, the demodulator, and the synchronizer. The clock controller 40 generates drive clocks of the modulator, the demodulator, and the synchronizer, respectively. In this case, the wireless modem comprises a modulator for converting transmission digital data into a radio signal, a wireless core module for receiving the radio signal, a demodulator for converting the signal received from the wireless core module into digital data, a synchronizer for synchronizing a base station with a terminal using a preamble in the reception signal, and a clock controller, wherein the clock controller generates three drive clocks of the modulator, the demodulator, and the synchronizer, respectively.

In the present embodiment, the clock controller 40 can be adapted to identify a start point of the drive interval of the modulator 10 by the signal START_ENC of FIG. 3, and identify an end point of the drive interval of the modulator 10 by the signal END_MOD of FIG. 3. Also, the clock controller can be adapted to identify a start point of the drive interval of the demodulator 20 by the signal START_DEM of FIG. 3 which indicates a start point of the preamble interval, and identify an endpoint of the drive interval of the demodulator 20 by the signal END_DEC of FIG. 3. Thus, description which can be easily inferred from FIG. 3 will be omitted.

Third, more complicated division of the functional blocks will be described. In other words, a case when the number of functional blocks is more than the case described in FIG. 3 will be described. In order to reduce power consumption to the maximum degree, it should be adapted to control the drive clock of each component illustrated in FIG. 2. However, this is not preferable because there are components operating during the substantially similar interval. In FIG. 2, the components having a definite difference in the operation interval are the Fourier transformer 22, and the inverse Fourier transformer 15. This is because it takes a time to collect time-axis signals. This case will be described below with distinction between the modulator and the demodulator. Here, the clock controller 40 will be regarded as one of the components constituting the modulator or the demodulator.

In the present embodiment, the modulator 10 comprises the channel encoder 11 for encoding data to be transmitted, the interleaver 12 for rearranging output data of the encoder, the mapping blocks 13 and 14 for allocating output data of the interleaver 12 to subcarriers, the inverse Fourier transformer 15 for converting frequency-axis output signals of the mapping block into time-axis signals, and the clock controller 40 for grouping the components into at least two groups and generating the drive clock of each group.

When allocation of signals to frequency bands intended for inverse Fourier transform is completed at the subcarrier allocator 14, a signal END_MAP indicating an end point of the operation interval of each mapping block is generated, and the clock controller 40 receiving the signal END_MAP inactivates the drive clock of each mapping block. The drive clock for each of the mapping blocks 13 and 14 may be activated by the signal START_ENC or START-MOD of FIG. 3.

When the frequency band signal sufficient to perform inverse Fourier transform is input from the subcarrier allocator 14, a signal START_IFFT indicating a start point of the drive interval of the inverse Fourier transformer 15 is generated, and the clock controller 40 receiving the signal START_IFFT activates the drive clock of the inverse Fourier transformer 15. The clock controller 40 receiving the signal END_MOD of FIG. 3 inactivates the drive clock of the inverse Fourier transformer 15.

The signals END_MAP and START_IFFT may be generated from the data input buffer included in the subcarrier allocator 14 or the inverse Fourier transformer 15. Description of the start points and end points of the other functional blocks will be omitted since it can be easily inferred from the description of FIG. 3.

Meanwhile, the demodulator 20 comprises the Fourier transformer 22 for converting a time-axis reception signal into a frequency-axis signal, the demapping blocks 23 and 24 for extracting data superimposed on an output signal of the Fourier transformer, the deinterleaver 25 for rearranging output data of the demapping blocks in original order, the channel decoder 26 for decoding output of the deinterleaver, and the clock controller 40 for grouping the components into at least two groups, and generating the drive clock of each group.

When the Fourier transform performed by the Fourier transformer 22 is completed, a signal END_FFT indicating an end point of the Fourier transformer 22 is generated, and the clock controller 40 receiving the signal END_FFT inactivates a drive clock of the Fourier transformer 22. The drive clock for the Fourier transformer 22 may be activated by the signal START_DEM of FIG. 3.

When the Fourier transform of the Fourier transformer 22 is performed enough for channel estimation operation of the channel estimator 23, a signal START_DMP indicating a start point of the drive interval of each of the demapping blocks 23 and 24 is generated, and the clock controller 40 receiving the signal START_DMP activates the drive clock of the demapping blocks 23 and 24. The clock controller 40 receiving the signal END_DEC or END_DEM of FIG. 3 inactivates the drive clock of the demapping blocks 23 and 24.

The signals END_FFT and START_DMP may be generated from the channel estimator 23, the Fourier transformer 22, or the data output buffer included in the Fourier transformer. Description of start points and end points of the other functional blocks will be omitted since it can be easily inferred from description of FIG. 3.

According to an embodiment, the clock control for each of the channel estimator 23, the symbol demapper 24, the symbol mapper 13, and the subcarrier allocator 14 may be performed in greater detail in the similar way.

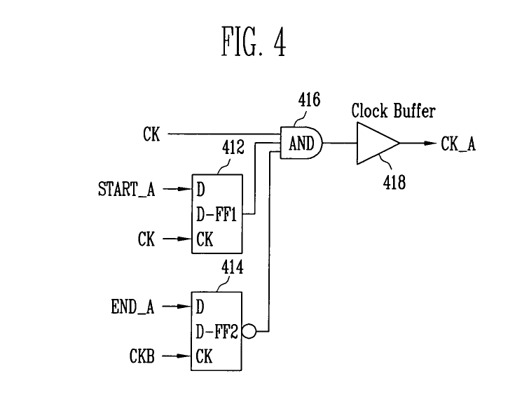

FIG. 4 illustrates an embodiment of a unit circuit for generating a drive clock of a functional block in a clock controller according to an exemplary embodiment of the present invention. Since the drive clock CK_A of each functional block is generated using a main clock CK in the present embodiment, it is most efficient to use two flip-flops and a 3-input AND gate as illustrated.

A start point signal START_A of the drive interval of an input functional block is input to a first flip-flop D-FF1 412 driven by the main clock CK. An end point signal END_A of the drive interval is input to a second flip-flop D-FF2 414 driven by an inversion clock CKB of the main clock. The 3-input AND gate 416 to which the main clock CK, the output of the first flip-flop 412, and the inversion value of the output of the second flip-flop 414 are input performs AND operation. Output of the AND gate 416 is input to the drive clock CK_A of a corresponding functional block through a clock buffer 418.

With a wireless modem or a modulator/demodulator according to the present invention as described above, it has an effect of reducing power consumption in an active mode where a main clock is activated. For this purpose, a drive clock is input only when a main functional block operates even though it is in the active mode where the main clock is activated, and the drive clock is prevented during an idle interval.

Also, the present invention has another effect of minimizing unnecessary power consumption caused by clock switching.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A wireless modem, comprising:
a wireless core module for transmitting and receiving a radio signal;
a modulator for converting data to be transmitted into a wireless transmission signal and transmitting the converted signal to the wireless core module;
a demodulator for converting the signal received from the wireless core module into reception data;
a synchronizer for synchronizing the signal received from the wireless core module; and
a clock controller for generating a drive clock of each of the modulator, the demodulator, and the synchronizer.

2. The wireless modem of claim 1, wherein:
the modulator performs interleaving for rearranging a sequence of transmission data; and
the clock controller generates the drive clock of each of the blocks before and after the interleaving of the modulator.

3. The wireless modem of claim 2, further comprising an interleaving buffer for buffering the transmission data input to perform the interleaving during a predetermined interval, wherein the clock controller stops the drive clock of the block before the interleaving or starts the drive clock of the block after the interleaving, according to an amount of data received into the interleaving buffer.

4. The wireless modem of claim 1, wherein:
the modulator performs inverse Fourier transform converting a frequency-axis signal into a time-axis signal; and
the clock controller generates the drive clock of each of the blocks before and after the inverse Fourier transform of the modulator.

5. The wireless modem of claim 4, further comprising an inverse Fourier buffer for buffering the time-axis signals generated by the inverse Fourier transform during a predetermined interval, wherein the clock controller stops the drive clock of the block before the inverse Fourier transform and starts the drive clock of the block after the inverse Fourier transform, according to an amount of data received into the inverse Fourier buffer.

6. The wireless modem of claim 1, wherein:
the demodulator performs deinterleaving for rearranging received digital data in original order; and
the clock controller generates the drive clock of each of the blocks before and after the deinterleaving of the demodulator.

7. The wireless modem of claim 6, further comprising a deinterleaving buffer for buffering the digital data generated by performing the deinterleaving, wherein the clock controller stops the drive clock of the block before the deinterleaving and starts the drive clock of the block after the deinterleaving, according to an amount of data received into the deinterleaving buffer.

8. The wireless modem of claim 1, wherein:
the demodulator performs Fourier transform converting a time-axis signal into a frequency-axis signal; and
the clock controller generates the drive clock of each of the blocks before and after the Fourier transform of the demodulator.

9. The wireless modem of claim 8, further comprising a Fourier buffer for buffering the time-axis signals input to perform the Fourier transform during a predetermined interval, wherein the clock controller stops the drive clock of the block before the Fourier transform and starts the drive clock of the block after the Fourier transform, according to an amount of data received into the Fourier buffer.

10. The wireless modem of claims 1, further comprising an analog controller for controlling mutual operation between the demodulator and the wireless core module, wherein the clock controller generates the drive clock of each of the demodulator and the analog controller.

11. A modulator, comprising:
an encoder for encoding data to be transmitted;
an interleaver for rearranging output data of the encoder;
a mapping block for allocating output data of the interleaver to subcarriers;
an inverse Fourier transformer for converting a frequency-axis output signal of the mapping block into a time-axis signal; and
a clock controller for grouping the components into at least two functional block groups, and generating a drive clock of each group.

12. A demodulator, comprising;
a Fourier transformer for converting a time-axis reception signal into a frequency-axis signal;
a demapping block for extracting data superimposed on an output signal of the Fourier transformer;
a deinterleaver for rearranging output data of the demapping block in original order;
a decoder for decoding output of the deinterleaver; and
a clock controller for grouping the components into at least two groups, and generating a drive clock of each group.
